(19) United States
(12) Patent Application Publication
(10) Pub. No.: US 2004/0181531 A1
(43) Pub. Date: Sep. 16, 2004

(54) Speed pass system

(76) Inventor: Clark Becker, Victoria, MN (US)

Correspondence Address: Beck & Tysver, P.L.L.C, Suite 100, 2900 Thomas Avenue S., Minneapolis, MN, 55416, US

(21) Appl. No.: 10/799,096

(22) Filed: Mar. 12, 2004

Related U.S. Application Data
(60) Provisional application No. 60/453,991, filed on Mar. 12, 2003.

(51) Int. Cl. G06F 7/00

(52) U.S. Cl. 707/9

(57) ABSTRACT

A customer identifier system aids in providing personalized web browsing in a public or semi-public internet kiosk. The system further aids in streamlining the process of signing a customer up for subscription services.

This application claims priority to U.S.S.No. 60/453,991, filed Mar. 12, 2003.

### FIELD OF THE INVENTION

The present invention relates generally to a system of using a customer or user identifier to quickly gain access to stored information about a user to assist in accessing or setting up services and for facilitating a user's access to their preferred internet portal from a public or semi-public kiosk.

### BACKGROUND OF THE INVENTION

Typically, a person configures their home computer, PDA, web-enabled cell phone and like devices to use their preferred internet portal for accessing the internet. User's are comfortable and familiar with the portal they are accustomed to using on their own devices. Using a device that the user does not own, such as public or semi-public kiosks, can be cumbersome or frustrating since it is not configured with the user's preferences, settings and familiar portal home page and services.

Retail stores are increasingly using kiosks within their stores to provide product information and other services, and in some cases proving web content. It is desirable for user's to be able to interact with the internet using their personal preferred web portal within the retail store setting.

A variety of services are sold to customers within the retail store setting, particularly services relating to products sold in the store. Examples of such services include maintenance contracts, subscription services for cellular phone service, loyalty programs, electronic wallet, wireless internet service, subscriptions for trying and purchasing digital media, subscriptions for web-based content requiring a subscription, and subscriptions for email accounts. Setup for each such service requires the collection of data from the customer such as the name, address and credit card. It is desirable for a system to streamline the process of collecting this data from the user.

### SUMMARY OF THE INVENTION

Through a user identifier and a database storing user data in association with the user identifier, public or semi-public kiosks can deliver a personalized internet experience. Further, a user identifier and a database storing user data streamlines the process of setting up or using a variety of services. The system, method and device of the present invention offer particular advantage when used in the context of a kiosk located within a retail store setting or in the context of a store through which the subscription to many kinds of goods or services are sold or made available.

According to one aspect of the system, a device is provided that can “read” the customer's or “user's” identifier. This reader device is compatible with a format by which the user's identifier is embodied. For example, a card having a magnetic stripe with the user's identifier could be used to embody the user's identifier; in such a case, the system includes a mag-stripe reader. Alternatively, the reader may instead be a numeric or alpha-numeric keypad or keyboard. A database stores the user identifier in association with the user data. For example, this user data may include the user's preferred internet portal and login information for the portal. The database is coupled to the reader for data communication therebetween. A display device, such as a monitor or screen, is coupled to an internet interface for displaying web content on the display device. The internet interface is further coupled to the database and receives from the database information related to the user. More specifically, when the reader sends the user's identifier to the database, the database returns to the internet interface at least portions of the user's data, such as the user's preferred internet portal and the user's login information. In this manner, the user is automatically logged into their preferred portal, and thereby have a personalized internet experience.

The physical embodiment of the user identifier can also be used to quickly access previously stored user data for automatically populating fields in forms for signing up for subscription services.

### BRIEF DESCRIPTION OF THE DRAWINGS

An exemplary version of a system and method for allowing a user to access the internet in a customer-specific manner using a public or semi-public kiosk, and for using customer-specific data for accessing or setting up services, is shown in the figures wherein like reference numerals refer to equivalent structure throughout, and wherein:

FIG. 1 is a flow chart illustrating a method of facilitating a user's access to the internet via a public or semi-public kiosk, using user-specific stored information; and

FIG. 2 is a schematic diagram of a system for using customer-specific information to access or set up services.

### DETAILED DESCRIPTION OF PREFERRED EMBODIMENT(S)

The present invention relates to a system 10 for customer-specific, two-way communication between a customer and a retail establishment and its partners or affiliates. In broadest terms, the system 10 provides a way for a customer to uniquely identify him/herself and for the customer to then have a digital interaction with the retailer or web content on the internet.

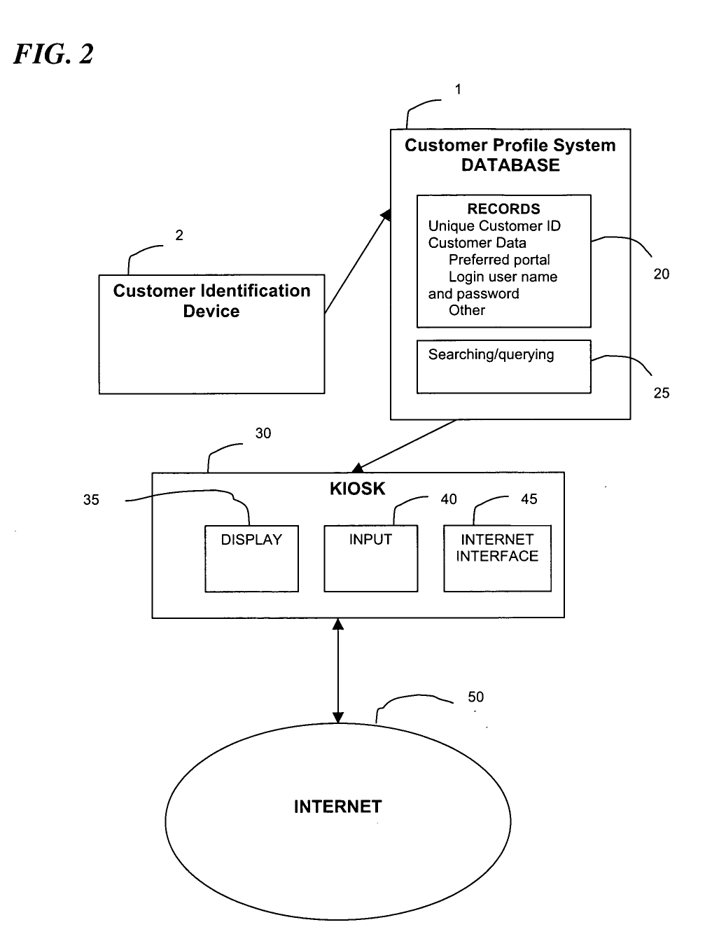

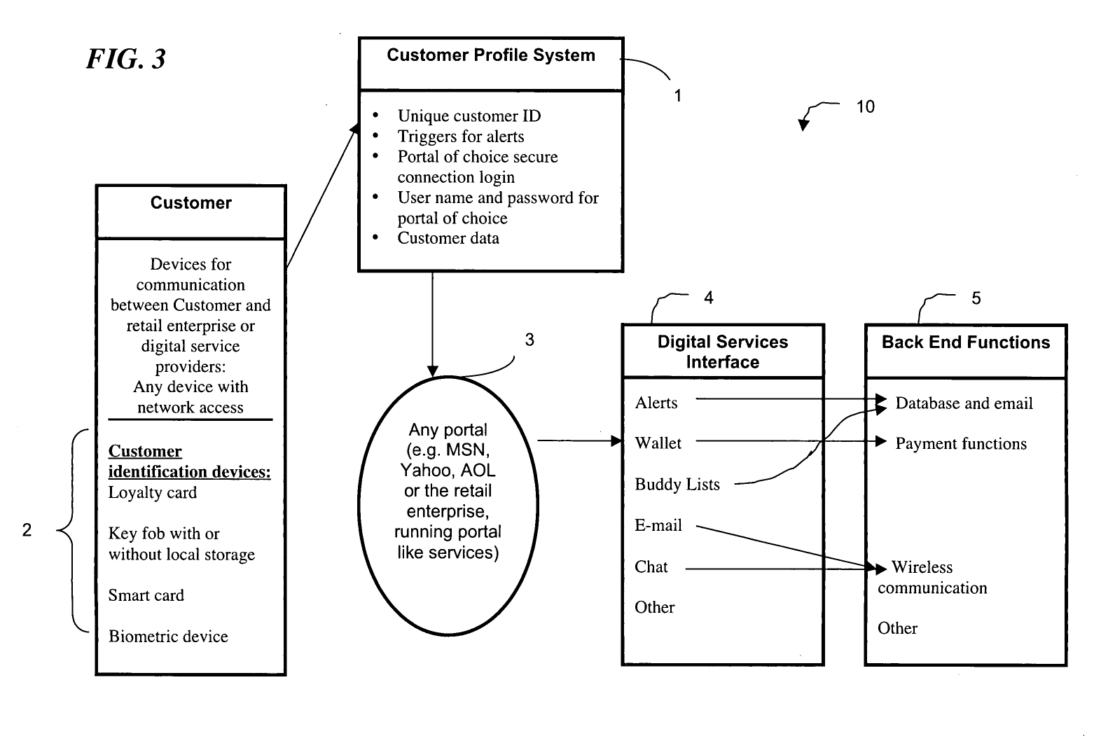

At the heart of the two-way communication system 10 is a customer profile system 1. As illustrated in FIG. 2, a customer profile system 1 includes a database which stores a unique customer identifier in conjunction with other information about the customer. In a preferred embodiment, the customer's internet portal or multi-portal of choice (e.g. MSN, AOL, Yahoo!) is stored in association with their unique identifier. Also stored in conjunction with the identifier is login information, such as username and password. Further information stored in conjunction with the identifier is / are triggers for alerts. The customer identifier may provide links to other data collected and used by the enterprise, such as name, address, credit card number and loyalty program data such as purchase history and point tally.

Associated with each customer or user is a physical embodiment of an identifier. The device 2 or “speed pass” can be any of a number of types of devices 2 using any of a number of types of technology for unique identification. For example, the device 2 might be a card with a magnetic stripe containing a unique identifier. When swiped by a mag-stripe reader, the system accesses the customer profile system 1 using the unique identifier. Alternatively, the customer identification device 2 might be a card with a unique identifier printed or imprinted or embossed thereon that can be read and manually typed by a person. Other examples of potential customer identification devices 2 include smart cards (with data storage therein) and biometric devices which can read a unique biological marker, such as a fingerprint. The customer identification device 2 might be incorporated into a key fob for the customer's convenience.

According to one aspect of this invention, a retail establishment has one or more customer identification stations or kiosks or terminals in a store which can read the customer identification device 2 and access the customer profile database 1, to provide quick access to the information stored in association with the customer's identifier. Further, this system contemplates that the retail establishment has one or more internet access stations or kiosks operatively coupled with the customer identification stations. Alternatively, the customer may interact with internet content on any device which can access the internet, including the customer's own computer, PDA, smart phone or the like. “Interaction” may be either under the customer's instigation and control, or may involve the retailer sending messages or content to the customer's internet device (i.e. the retailer may “push” web pages to the customer's device, preferably at the customer's invitation such as via “alerts” established by the customer.)

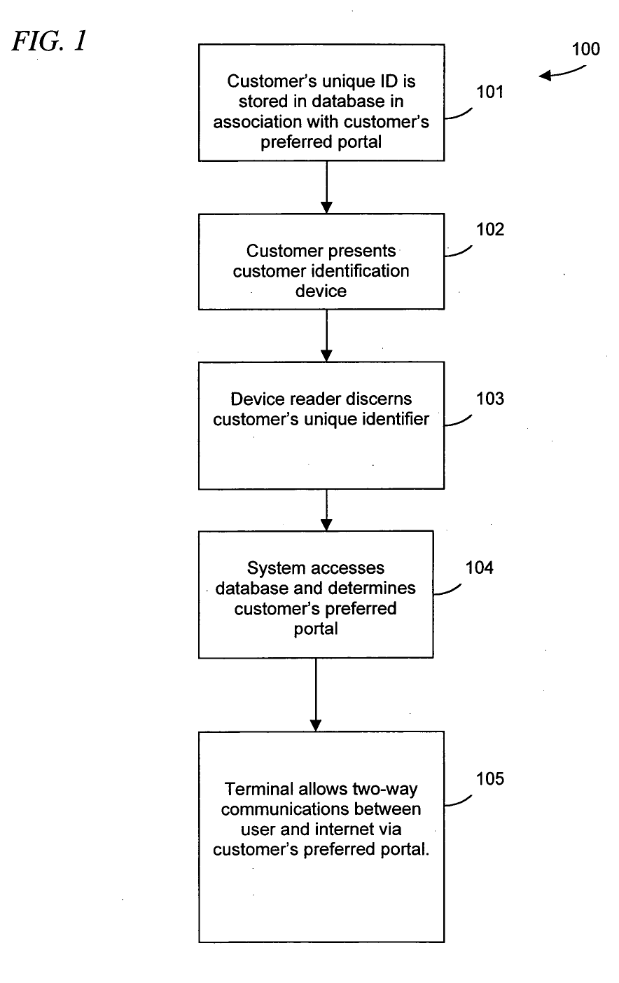

As shown in FIG. 1, the method (100) for using the system includes storing (101) a customer's unique identifier in the customer profile system 1 in conjunction with other data regarding the customer, such as their preferred internet portal 3. When a customer visits a retail establishment, the customer presents (102) his or her customer identification device 2 to a device reader. For example, if the identification device 2 is in the form of a card or key fob with a magnetic stripe, the customer or a clerk swipes the card in a mag-stripe reader. The device reader discerns the customer's unique identifier (103). The system accesses the customer profile system 1 and determines the customer's preferred portal (104). A terminal or computer station then allows two-way communication between the customer and the internet via the customer's preferred portal 3 (105).

FIG. 2 illustrates components of the preferred system. The customer identification device or reader 2 is coupled to a database 1 in which is stored a customer profile system housing customer's records 20 and having searching and querying capabilities 25. The kiosk or internet access station 30 has or is operatively connected to a display, monitor or screen 35, an input device 40 such as a keyboard, mouse, touchsensing capabilities, voice recognition or the like. Further, the kiosk 30 has an internet interface 45 by which the kiosk 30 can send information to and receive information from the internet 50.

Turning to FIG. 3, the system provides a digital services interface 4 that allows the customer user to access alerts, a digital wallet, buddy lists, email and chat. In one embodiment, the system allows the user to interact with content and then easily use the digital services. For example, in a music store, the system allows the user to sample music content, then set up an alert to receive messages when news, such as significant events or new releases about the sampled band, is published. Other examples of content that a user is allowed to view and interact with include movies and games.

Because these digital services are provided in conjunction with the user's known identity, the services can be coordinated with their customer profile. For example, the system allows users to send content, such as a song file, to a friend via email or to a mailing list. Further, the user might request information on purchasing tickets to a concert of a band they are “viewing” online, and the system can advise of a location, near the user's home, where tickets can be purchased or purchase tickets online.

In another example, the customer's profile identifier is linked to the customer's data in a loyalty program. Thus, when the customer identifies him/herself in the store, the system is able to display loyalty points; further, the system may allow the customer to acquire loyalty points by interacting with content or forwarding messages to others. Still further, the system can send or display alerts to the user, upon identification, regarding topics stored by the user in their customer profile 1. Such alerts can be delivered to the user via other devices besides the in-store terminal or kiosk, such as via cell phones, PDAs, and the like.

Another feature of the system is advantageous in conjunction with digital “wallets”. Typically in the past, to set up a digital wallet, the customer would enter data manually into the portal e-wallet database, including the customer's name, address and credit card information. Through use of the customer profile system, the set-up of a digital wallet is streamlined, reducing the amount of time that a customer and store clerk must spend setting up a wallet. When a customer seeks to establish a digital wallet, the customer can use the customer profile system to identify him/ herself; then, data specific to the customer, like address and credit card information, can be imported into or used by the wallet, so that such information does not have to be entered for the wallet.

Similarly, the customer profile system can be used to streamline the point of sale process required for purchase of items. The unique identifier device or biometric reader opens up a connection through the customer profile to the customer e-wallet. The tendering process of a sale for anything from a can of soda in a machine to check-out at a retail location is simplified as card presentment is eliminated. Potential fraud is also reduced as the customer no longer passes credit card information to other individuals.

The customer profile system is also advantageously used in the “real-time provisioning of services”. This includes signing the customer up for support services for devices that they buy. For example, if a customer purchases a cell phone, he/she will require service from a cell phone company. As another example, when a customer buys a PDA with wireless internet connection, he/she will need a contract for the wireless service. When a user buys a computer, he/she may also want to establish an email account. By allowing the user to sign up for such services using the customer identification system, much information about the customer can be accessed and used without the customer or sales clerk having to manually collect the customer's pertinent data.

As apparent from the description above, the digital services interface 4 provides linking to various back-end functions 5. For example, when a user requests an alert, triggers for the alert are saved in a database in association with or linked to the customer's unique identifier and to the user's email account, so that alerts can be sent to the user's email. The wallet service is linked to payment functions typically through third party credit vendors. Email and chat services are linked to wireless communication providers.

Although an illustrative version of the device is shown, it should be clear that many modifications to the device may be made without departing from the scope of the invention.

It is claimed:

1.) A kiosk system, comprising:
a) means for entering customer identifier;
b) database containing customer identifier stored in association with the customer preferred internet portal; said database coupled to said means for entering customer identifier for data communication therebetween;
c) display;
d) means for accessing the customer's preferred portal, said portal accessing means operatively coupled to said database and to said display for displaying the customer's preferred portal.

2. A kiosk system according to claim 1, wherein said means for entering customer identifier includes a magnetic card reader for reading a customer's card bearing a magnetic stripe that contains the customer identifier.

3. A kiosk system according to claim 1, wherein said means for entering customer identifier includes an alpha-numeric keypad.

4. A kiosk system according to claim 1, wherein said means for entering the customer identifier includes a smart card reader.

5. A kiosk system according to claim 1, wherein said means for entering the customer identifier includes a biometric reader.

6. A method of providing personal internet access via a multi-customer kiosk, comprising the steps of:
a) providing a kiosk having a customer input device, a display, and a data connection to the internet to display web content on the display;
b) storing customer's unique identifier in a database in association with the customer's profile information including the customer's preferred internet portal and log-in information;
c) coupling the kiosk to the database for data communication therebetween to allow the kiosk send to the database a unique customer identifier and for returning to the kiosk the customer's preferred portal and log-in information;
d) connecting to the internet via the kiosk and logging into the customer's preferred portal using the customer's log-in information.

7. A method of providing personal internet access via a multi-customer kiosk according to claim 6, further comprising the steps of:
a) providing a card bearing a customer's identifier;
b) providing a card reader, in data communication with said kiosk, for reading the customer's identifier from the card;
c) authomatically logging into the customer's preferred internet portal upon presenting the card to the card reader.

8. A method according to claim 7 wherein said card includes a magnetic stripe bearing the customer's identifier and wherein said card reader is a mag-stripe reader.

9. A method according to claim 7 wherein said card is a smart card and said card reader is a compatible smart card reader.
